(19) United States
(12) Patent Application Publication
(10) Pub. No.: US 2010/0231720 A1
(43) Pub. Date: Sep. 16, 2010

(54) Traffic Monitoring

(76) Inventors: Mark Richard Tucker, Leicestershire (GB); John Martin Reeve, Coventry (GB)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 12/676,279

(22) PCT Filed: Sep. 3, 2008
(86) PCT No.: PCT/GB2008/002969

§ 371 Date: Apr. 28, 2010

(30) Foreign Application Priority Data
Sep. 5, 2007 (GB) 0717233.1

(51) Int. Cl. H04N 7/18

(52) U.S. Cl. 348/149; 348/E07.091

(57) ABSTRACT

A method of monitoring traffic on a road comprising capturing a plurality of images of the road using a camera mounted on a viewing point and associating a time of capture with each image, determining, from the captured images, the positions of the portions of the road surface visible from the viewpoint at the front and rear extremities of the extent of a vehicle in the captured images at two different times; and determining from the positions and the times of the instants at least one characteristic of the vehicle or its motion, such as the vehicle length, speed or a vehicle classification (truck, car, motorcycle, etc).

### CROSS-REFERENCE TO RELATED APPLICATIONS

This application is a national stage of International Application No. PCT/GB2008/002969 filed Sep. 3, 2008, the disclosures of which are incorporated herein by reference, and which claimed priority to Great Britain Patent Application No. 0717233.1 filed Sep. 5, 2007, the disclosures of which are incorporated herein by reference.

### BACKGROUND OF THE INVENTION

This invention relates to a method of and apparatus for traffic monitoring.

Inductive loops have been used in vehicle detection since around 1960. At the present date, these systems have been used all around the world to determine vehicle presence, occupancy time and speed. Inductive loops are the most common means of acquiring traffic statistics.

An inductive loop comprises a coil of wire embedded in a groove in the road surface. In order to perform this embedding, approval must be given by the road authorities and much manual work must be carried out in forming the hole into which the coil is placed. Furthermore, it is not possible for traffic to use the section of road in which the coil in being installed during installation. The installation is therefore often time consuming and costly. Furthermore, carriageway works such as resurfacing tend to lead to destruction of the loops and so require reinstallation of the loops in the road surface.

When a vehicle crosses over an inductive loop, its inductance is reduced by the self-induction phenomenon. Signal processing and electronic circuitry measure the changing inductance. When the change in inductance passes a threshold, a vehicle is considered to be present; when the inductance rises again the vehicle is no longer considered to be present. The time for which the vehicle is determined to be present is dependent upon the thresholds set and also on the magnetic signature of the vehicle.

When correctly set, inductive loops can be accurate, errors in times of vehicle arrival and departure due to incorrect threshold setting and variances in magnetic properties of different vehicles can easily propagate to the calculation of occupancy—that is, the fraction of the total time that the section of road in question is occupied.

When the use of two separate loops a known distance apart allows for the vehicle speed to be determined, if the performance of the two loops differs, then the difference in timing in threshold-crossing may lead to errors in measured speed. Similarly, determining the length of a vehicle from the product of the vehicle speed and the length of time it is over one of the loops can be subject to the same errors. Additionally, differences in detecting vehicles made of combinations of units, such as tractor units pulling trailers, may lead to further measurement errors.

Classifying vehicles using the output of inductive loops is also problematic. Similar vehicles, for example trucks, may have dissimilar magnetic signatures, whereas dissimilar vehicles, such as small trucks and large cars, may have indistinguishable magnetic signatures. Additionally, where pairs of inductive loops are employed in lanes, vehicles crossing lanes between the pairs of loops may not be detected correctly. Also, inductive loops have difficulties operating correctly for vehicle speeds of over 100 km/h.

Taking all of these factors into account, inductive loops have been considered to have a 3% counting accuracy on the number of vehicles passing over the loop, and a 5% accuracy on vehicle speed. It is therefore desired to provide a traffic monitoring system that does not rely on inductive loops.

### BRIEF SUMMARY OF THE INVENTION

A first aspect of the invention provides a method of monitoring traffic on a road comprising:

capturing a plurality of images of the road using a camera mounted on a viewing point and associating a time of capture with each image.
determining, from the captured images, the positions of the portions of the road surface visible from the viewpoint at the front and rear extremities of the extent of a vehicle in the captured images at two different times;
and determining from the positions and the times of the instants at least one characteristic of the vehicle or its motion.

Such a method provides a simple, reliable method that can be used to replace inductive loops. No interference with the road surface is required. All that is required is that the camera, be able to view the road surface, typically from some height. Typical installation positions could include on bridges or gantry over the road.

It is not necessary that the positions of road surface visible at the front and rear extremities of the vehicle be taken at the same time; the position of the road surface visible at the front extremity of the vehicle may be determined at two points in time, and the position of the road surface visible at the rear extremity of the vehicle may be determined at two different points in time. However, it is possible to determine the position of the road surfaces at the front and rear extremities of the vehicle for simultaneous instants, as long as two temporally spaced position measurements are made for each extremity.

The characteristics of the vehicle or its motion may comprise at least one of the vehicle length, height, width and speed.

In one embodiment, referred to as the line embodiment, the measurements may be taken at the times when the vehicle blocks the view from the camera of a first line across the road and a second line across the road, the first and second lines being spaced from one another along the road; and when the first and second lines are revealed due to passage of the vehicle along the road. This means that the positions at the appropriate times will be accurately known, as the positions of the lines will generally be known in advance.

In one embodiment, the first and second lines may be visible features on the road surface; for example, they may be painted lines across the carriageway. However, this is not required, and the method may instead comprise the assignment of areas of road surface within the field of view of the camera as the first and second lines. Whilst physical lines on the surface of the carriageway are thought to be more accurate, the use of “virtual” lines assigned to the areas of carriageway but typically only existing within the apparatus carrying out the method requires less interference with the road.

Where the characteristics include vehicle speed, the method may comprise determining the vehicle speed using the time elapsed between the blocking and revealing of at least one of the first and second lines. This may combined with the distance between the first and second lines. The distance between the first and second lines may be predetermined, as where lines are painted on the road surface a known distance apart, or may be determined as part of the assignment procedure discussed above.

The method may comprise determining the speed of the vehicle according to:

$$V = \frac{Δ x}{Δ tf}$$

where V is the vehicle speed, Δx is the distance between the first and second lines along the road and Δtf is the time elapsed between the closest edge of the vehicle to the camera in the field of view traversing the first and second lines.

The height of the vehicle may be calculated as:

$$h = H \frac{Δ tf - Δ tr}{Δ tf}$$

where h is the vehicle height, H is the height above the road surface that the camera is mounted, Δtf is the time elapsed between the closest edge of the vehicle to the camera in the field of view traversing the first and second lines and Δtr is the time elapsed between the farthest edge of the vehicle to the camera in the field of view traversing the first and second lines.

The length of the vehicle may be calculated as:

$$l = \frac{xf 1 \cdot Δ t 2 - xf 2 \cdot Δ t 1}{Δ tf}$$

where l is the length of the vehicle, Δt1 is the time elapsed between the first line being blocked and revealed, Δt2 is the time elapsed between the second line being blocked and revealed, Δtf is the time elapsed between the vehicle blocking the first and second lines, xf1 is the distance from the point on the road directly underneath the camera to the first line and xf2 is the distance from the point on the road directly underneath the camera to the second line.

In another embodiment of the invention, referred to as the two image embodiment, the times for which the positions are calculated may be the times at which two images are captured. In such a case, the time at which the image is captured will generally be accurately known, typically more so than with a line-crossing which could occur between successive image captures. Indeed, this allows a lower frame rate to be used than the line crossing technique without significantly lowering accuracy.

The method may comprise capturing the first of the two images when the vehicle is in a first zone within the field of view of the camera, and then waiting until the vehicle enters a second zone of the field of view before designating the second image as such. The use of two zones ensures that different parts of the field of view are used, avoiding measurement bias due to preferentially selecting one part of the image.

The speed of the vehicle may be calculated according to:

$$V = \frac{Δ xf}{Δ t}$$

where Δxf is the change in distance from the camera along the road of the closest extremity of the vehicle to the camera and Δt is the time elapsed between the two times.

The height of the vehicle may be calculated according to:

$$l = \frac{xf 1 \cdot xr 2 - xf 2 \cdot xr 1}{xr 1 - xr 2}$$

where xf1 is the distance along the road from a point directly underneath the camera to the closest edge of the vehicle in a first one of the two images, xf2 is the distance along the road from the point directly underneath the camera to the closest edge of the vehicle in a second one of the two images, xr1 is the distance along the road from the point directly underneath the camera to the point on the road visible next to the farthest edge of the vehicle in the first of the two images and xr2 is the distance along the road from the point directly underneath the camera to the point on the road visible next to the farthest edge of the vehicle in the second of the two images.

The height of the vehicle may be calculated according to:

$$h = H ( 1 - \frac{xf 1 - xf 2}{xr 1 - xr 2} )$$

where H is the height of the camera above the road, xf1 is the distance along the road from a point directly underneath the camera to the closest edge of the vehicle in a first one of the two images, xf2 is the distance along the road from the point directly underneath the camera to the closest edge of the vehicle in a second one of the two images, xr1 is the distance along the road from the point directly underneath the camera to the point on the road visible next to the farthest edge of the vehicle in the first of the two images and xr2 is the distance along the road from the point directly underneath the camera to the point on the road visible next to the farthest edge of the vehicle in the second of the two images.

The step of determining the position of the road surface visible at the extremities of the vehicle may comprise determining the shape of the road surface and using the shape of the road surface to transform a position within the image into a physical position on the road.

The method may comprise using one of the line and two image embodiments to calculate the characteristics, and then using the other embodiment to calculate the characteristics at a second time.

The method may comprise the step of applying a temporal high pass filter to the images, so that only fast changes in the images are considered. This prevents longer-term trends, such as changes in ambient light due to the sun's movement across the sky or weather, affecting the detection of the visibility of the lines.

The method may comprise determining the width of the vehicle dependent upon the amount of the line that is blocked by the vehicle.

The method may comprise the step of counting vehicles crossing one of the first and second lines. As such, the method may comprise incrementing a counter every time one of the following events occurs:
first line being blocked, or second line being blocked
first line being revealed, or second line being revealed
determining the vehicle characteristics.

The method may comprise determining the flow rate of vehicles as the count of vehicles divided by the period to which the count relates. The occupancy—that is fraction of the time the portion of road is occupied—may be determined by summing l/V for each vehicle for a given period and dividing the sum by the length of the period. Alternatively, the occupancy can be determined as the proportion of time that one of the first and second lines is visible in the camera view; preferably the line closest to the camera is used. The method may also comprise determining an average vehicle speed over a plurality of vehicles.

A second aspect of the invention provides a traffic monitoring apparatus, comprising:

a camera having an output and arranged so as to, in use, capture images and to output the captured images at the output,
and a processing unit, coupled to the output of the camera and arranged to, in use, analyse the captured images,
in which the processing unit comprises a position determination unit arranged to take, in use as its input, a plurality of images of a road and a vehicle travelling along the road captured by the camera, the plurality of images being taken of the road at different times, the time of capture of each image being associated with that image, and to output, in use, the positions of the portions of the road surface visible from the camera at the front and rear extremities of the extent of the vehicle in the captured images at two different times;
and a characteristic determining unit arranged to take as an input, in use, the positions and the times of the instants and to output, in use, at least one characteristic of the vehicle or its motion.

It is not necessary that the positions of road surface visible at the front and rear extremities of the vehicle be taken at the same time; the position of the road surface visible at the front extremity of the vehicle may be determined at two points in time, and the position of the road surface visible at the rear extremity of the vehicle may be determined at two different points in time. However, the position determining unit may be arranged to determine the position of the road surfaces, in use, at the front and rear extremities of the vehicle for simultaneous instants, as long as two temporally spaced position measurements are made for each extremity.

The characteristics of the vehicle or its motion may comprise at least one of the vehicle length, height, width and speed.

In one embodiment, the position determining unit may be arranged to determine the times when the vehicle blocks the view from the camera of a first line across the road and a second line across the road, the first and second lines being spaced from one another along the road; and when the first and second lines are revealed due to passage of the vehicle along the road. This means that the positions at the appropriate times will be accurately known, as the positions of the lines will generally be known in advance.

In one embodiment, the first and second lines may be visible features on the road surface; for example, they may be painted lines across the carriageway. However, this is not required, and the processing unit may comprise memory arranged to record in use the assignment of areas of road surface within the field of view of the camera as the first and second lines. Whilst physical lines on the surface of the carriageway are thought to me more accurate, the use of “virtual” lines assigned to the areas of carriageway but typically only existing within the apparatus carrying out the method requires less interference with the road.

Where the characteristics include vehicle speed, the characteristic determining unit may be arranged to determine, in use, the vehicle speed using the time elapsed between the blocking and revealing of at least one of the first and second lines. This may combined with the distance between the first and second lines. The distance between the first and second lines may be predetermined, as where lines are painted on the road surface a known distance apart, or may be stored, in use, in the memory.

The characteristic determining unit may determine the speed of the vehicle according to:

$$V = \frac{Δ x}{Δ tf}$$

where V is the vehicle speed, Δx is the distance between the first and second lines along the road and Δtf is the time elapsed between the closest edge of the vehicle to the camera in the field of view traversing the first and second lines.

The characteristic determining unit may be arranged to determine the height of the vehicle as:

$$h = H \frac{Δ tf - Δ tr}{Δ tf}$$

where h is the vehicle height, H is the height above the road surface that the camera is mounted, Δtf is the time elapsed between the closest edge of the vehicle to the camera in the field of view traversing the first and second lines and Δtr is the time elapsed between the farthest edge of the vehicle to the camera in the field of view traversing the first and second lines.

The characteristic determining unit may be arranged to determine the length of the vehicle as:

$$l = \frac{xf 1 \cdot Δ t 2 - xf 2 \cdot Δ t 1}{Δ tf}$$

where l is the length of the vehicle, Δt1 is the time elapsed between the first line being blocked and revealed, Δt2 is the time elapsed between the second line being blocked and revealed, Δtf is the time elapsed between the vehicle blocking the first and second lines, xf1 is the distance from the point on the road directly underneath the camera to the first line and xf2 is the distance from the point on the road directly underneath the camera to the second line.

The position determining unit may be arranged so as to calculate the positions for the times at which two images are captured. In such a case, the time at which the image is captured will generally be accurately known, typically more so than with a line-crossing which could occur between successive image captures. Indeed, this allows a lower frame rate to be used than the line crossing technique without significantly lowering accuracy.

The position determining unit may be arranged to take, as an input, a first of the two images when the vehicle is in a first zone within the field of view of the camera, and a second image of the vehicle in the a second zone of the field of view. The use of two zones ensures that different parts of the field of view are used, avoiding measurement bias due to preferentially selecting one part of the image.

The characteristic determining unit may be arranged to determine the speed of the vehicle according to:

$$V = \frac{Δ xf}{Δ t}$$

where Δxf is the change in distance from the camera along the road of the closest extremity of the vehicle to the camera and Δt is the time elapsed between the two times.

The characteristic determining unit may be arranged to determine the height of the vehicle according to:

$$l = \frac{xf 1 \cdot xr 2 - xf 2 \cdot xr 1}{xr 1 - xr 2}$$

where xf1 is the distance along the road from a point directly underneath the camera to the closest edge of the vehicle in a first one of the two images, xf2 is the distance along the road from the point directly underneath the camera to the closest edge of the vehicle in a0 second one of the two images, xr1 is the distance along the road from the point directly underneath the camera to the point on the road visible next to the farthest edge of the vehicle in the first of the two images and xr2 is the distance along the road from the point directly underneath the camera to the point on the road visible next to the farthest edge of the vehicle in the second of the two images.

The characteristic determining unit may be arranged to determine the height of the vehicle according to:

$$h = H ( 1 - \frac{xf 1 - xf 2}{xr 1 - xr 2} )$$

where H is the height of the camera above the road, xf1 is the distance along the road from a point directly underneath the camera to the closest edge of the vehicle in a first one of the two images, xf2 is the distance along the road from the point directly underneath the camera to the closest edge of the vehicle in a second one of the two images, xr1 is the distance along the road from the point directly underneath the camera to the point on the road visible next to the farthest edge of the vehicle in the first of the two images and xr2 is the distance along the road from the point directly underneath the camera to the point on the road visible next to the farthest edge of the vehicle in the second of the two images.

The position determining unit may be arranged so as to, in use, determine the position of the road surface visible at the extremities of the vehicle by determining the shape of the road surface and using the shape of the road surface to transform a position within the image into a physical position on the road.

The processing unit may comprise a temporal high pass filter, which acts on the captured images, such that only fast changes in the images are considered by the processing unit. This prevents longer-term trends, such as changes in ambient light due to the sun's movement across the sky or weather, affecting the detection of the visibility of the lines.

The characteristic determining unit may be arranged so as to, in use, determine the width of the vehicle dependent upon the amount of each line that is blocked by the vehicle.

The processing unit may also comprise a counter, arranged to count vehicles crossing one of the first and second lines. The counter may be arranged to determine when at least one of the following events occurs:
first line being blocked, or second line being blocked
first line being revealed, or second line being revealed
determination of the vehicle or motion characteristics.

The apparatus may be arranged to carry out the method of the first aspect of the invention.

A third aspect of the invention provides a data carrier, carrying processor instructions which, when loaded onto a suitable processor cause it to carry out the method of the first aspect of the invention.

Other advantages of this invention will become apparent to those skilled in the art from the following detailed description of the preferred embodiments, when read in light of the accompanying drawings.

### BRIEF DESCRIPTION OF THE DRAWINGS

FIG. 1 shows a schematic view of the traffic monitoring apparatus of a first embodiment of the invention, viewing the traffic passing the apparatus at a first instant;

FIGS. 2 to 4 show the same view as FIG. 1, viewing the traffic passing the apparatus at second, third and fourth instants;

FIG. 5 shows a flowchart showing the method of operation of the apparatus of FIG. 1;

FIG. 6 shows an example view from the camera of the apparatus of FIG. 1;

FIG. 7 shows a schematic view of the traffic monitoring apparatus of a second embodiment of the invention, viewing the traffic passing the apparatus at a first instant;

FIG. 8 shows the same view as FIG. 7, viewing the traffic passing the apparatus at a second instant; and

FIG. 9 shows a flow chart showing the method of operation of the apparatus of FIG. 7.

### DETAILED DESCRIPTION OF THE INVENTION

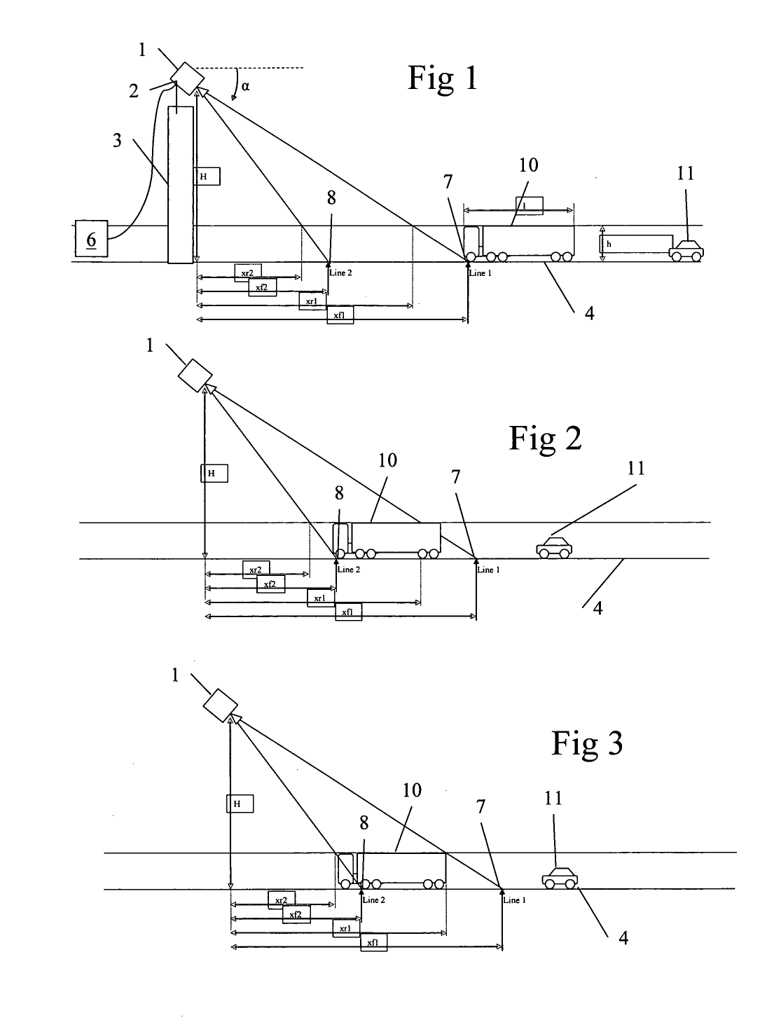

A traffic monitoring apparatus according to a first embodiment of the invention is shown in FIGS. 1 to 6 of the accompanying drawings. It comprises a camera 1 mounted on point 2 above a bridge or gantry depicted at 3. The camera is mounted so as to view a road 4 from its mounting point 2.

The camera is connected to a processing unit 6 which can be located distant from the camera 1. Alternatively, it can be located within the housing of the camera 1 or anywhere else convenient. Painted on the road surface are two lines—first line 7 and second line 8. The processing unit takes as an input images captured from camera 1. It analyses these images using techniques such edge analysis as discussed in WO02/092375 so as to determine when the lines are visible and when they are being blocked by the presence of vehicles on the road.

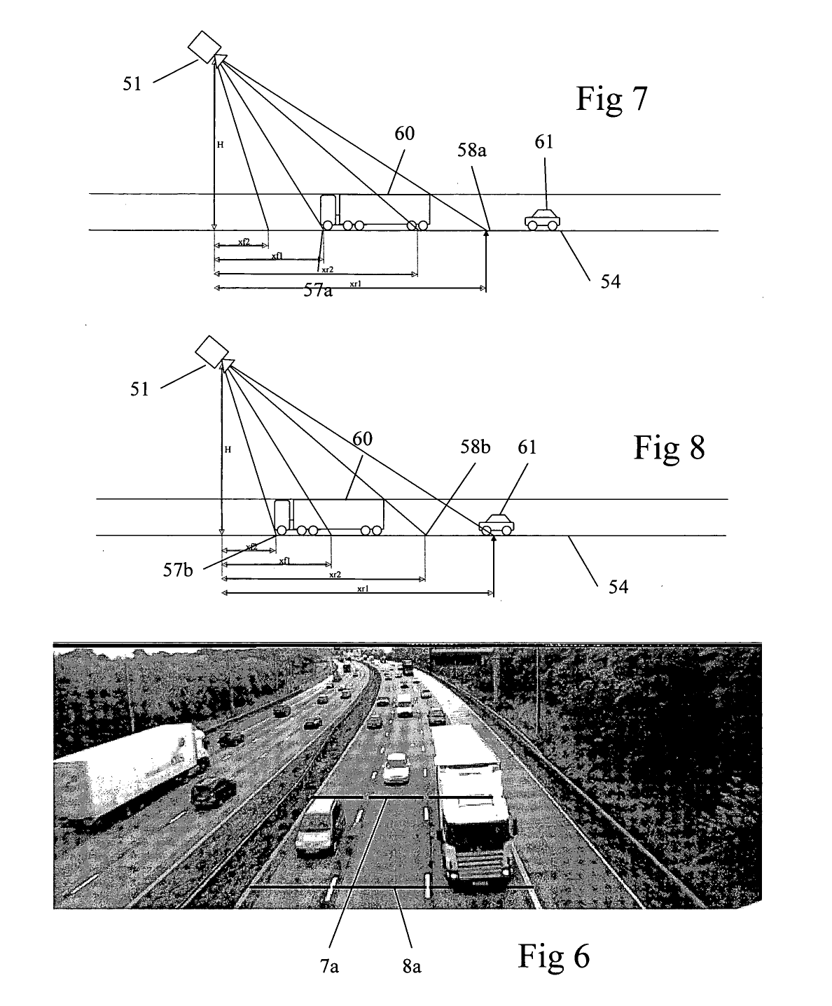

In an alternative embodiment, not directly depicted, the lines are not physically present on the surface of the road, but are each represented by an assignment stored in memory of the processor unit. Given that the camera is fixed relative to the road, the assigning a part of the captured image will correspond to the same area of road surface in each image, and so the processing unit in this case will determine whether the areas of road surface corresponding to the first or second lines are visible or if the view from the camera is blocked by the presence of a vehicle. An example captured image in such an embodiment is shown in FIG. 6 of the accompanying drawings; the areas assigned as first and second lines are shown as areas 7a and 8a respectively.

An advantage of using virtual crossing lines is that their placement can be changed and optimized online, according to specific algorithms, to suit the prevailing conditions (e.g. traffic speed, vehicle spacing). Also, no interference with the road surface is required.

The time of each vehicle covering and revealing each line is recorded, and can be used for calculating vehicle characteristics, such as the height, length and speed of the vehicles as will be demonstrated. Initially, stored in the processor unit are the facts that the camera is a height H above the road surface and that the first line 7 is a distance xf1 along the road surface from the point directly below the camera, and that the second line 8 is a distance xf2 along the road surface from the point directly below the camera. These distances along the road surface can be calculated by direct measurement in the case of painted lines, or determined in the case of “virtual” lines by measuring the height H and determining the camera pitch α.

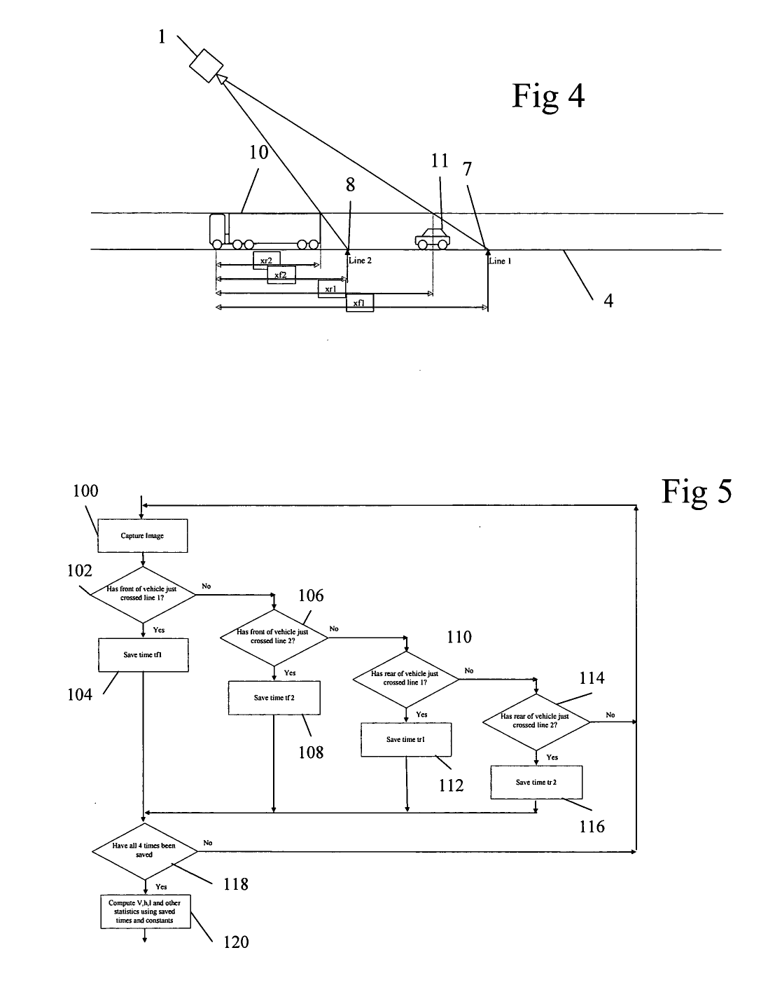

In the arrangement of FIG. 1, a vehicle 10 is at the instant of crossing the first line 7. The time is recorded as t=tf1. The vehicle continues along the road until it crosses the second line 8, as shown in FIG. 2. This time is recorded as t=tf2. Again, the vehicle continues travelling until the rear end of the vehicle reveals the first line, at time t=tr1 as shown in FIG. 3. The rear of the vehicle is now a distance xr1 from the point directly under the camera. Finally, the rear edge of the vehicle reveals the second line 8, at time t=tr2 as shown in FIG. 4, at a distance xr2 along the road from the point underneath the camera.

The following formulae can be derived from fixed parameters of the geometry of scene (i.e. H, xf1, and xf2) and the times (tf1, tf2, tr1, tr2) when the vehicle obscures or reveals the actual or virtual crossing lines 7, 8 detected by the video processing, where V is the vehicle speed, h the vehicle height and l the vehicle length:

$$V = - \frac{xf 1 - xf 2}{tf 1 - tf 2}$$

$$h = H * \frac{( tf 1 - tf 2 - tr 1 + tr 2 )}{( tf 1 - tf 2 )}$$

$$l = \frac{xf 1 ( tf 2 - tr 2 ) - xf 2 ( tf 1 - tr 1 )}{( tf 1 - tf 2 )}$$

The vehicle can then be classified (as a car, goods vehicle, motorcycle, etc) on the basis of its dimensions. The derivation of these formulae is included as Appendix A.

The method of detecting whether the lines are obscured can be made robust to changing light conditions by separating short term disturbances (indicating vehicle passage) from longer term trends (changing light conditions) by comparing the present image to the longer term modal average or applying a high pass filter, for example.

The system described functions with vehicles travelling towards or away from the camera. The system is therefore robust to changing traffic direction lane-by-lane, e.g. contra flow systems. Vehicles travelling in the wrong direction may also be readily detected.

Additional information can be derived using these measures:
Total vehicle count can be incremented every time a height and a length is computed, or simply whenever the visibility of the actual or virtual lines 1 or 2 changes.
Average speed over a specified moving average time period
Flow rate can be derived as the vehicle count divided by the time over which the count has occurred.
Occupancy can be the sum of the individual occupancies (l/V for each vehicle) divided by the time over which the count has occurred.
Occupancy may be measured more directly by the proportion of time that line 2 (or a third real or virtual line, independent of the above) is obscured if the camera pitch is selected such that a portion of the image is looking sufficiently downwards
Vehicle width may be derived from the portion of lines 1 and 2 that are obscured by each vehicle, allowing for perspective effects
‘Wrong way vehicles’ may be detected with manual operators informed immediately and able to verify the situation using the video feed

The optimum pitch of the camera and mounting height for the system is derived such that sufficiently accurate measurements are obtained whilst reducing missed targets and false data due to tailgating vehicles (particularly tall vehicles 10 leading short vehicles 11, as depicted in FIGS. 1 to 4). To further overcome the tailgating issue the camera may be mounted such that a portion of its field of view is sufficiently downwards or a second camera mounted above or below the first camera could be used.

Stereovision techniques could be used to detect the different ranges of the vehicles and so differentiate the end of the leading vehicle from the (occluded) front of the following vehicle. By capturing images of the same vehicle from different positions, it is possible to determine the range of the vehicle, which can then be correctly identified in the captured images.

A method of implementing this procedure can be seen in FIG. 5 of the accompanying drawings. In this, an image is captured at step 100 using camera 1. The processing unit 6 analyses the images, and determines whether a vehicle has just passed the first line 7 (step 102). If so, it records the present time as tf1 (step 104). Similarly, the method then goes on to check if the front of the vehicle has just crossed second line 8 (step 106, if so recording the present time as tf2 at step 108), if the rear of the vehicle has just cleared first line 7 (step 110, if so recording the present time as tr1 at step 112), and finally if the rear of the vehicle has just cleared the second line 8 (step 114, if so recording the present time as tr2 at step 116).

If no times have been recorded, then the system proceeds to capture another image at step 100. If a time has been recorded, then it is determined at step 118 whether all four times tf1, tf2, tr1, tr2 have been recorded. If not, then again the system reverts to capturing another image (step 100) until all four times have been captured.

Finally, once all four times have been recorded, at step 120 the system uses the formulae given about to work out the speed, height and length and so on the vehicle.

A second embodiment of the invention will now be discussed with reference to FIGS. 7 to 9 of the accompanying drawings. Common features to the first embodiment have been indicated with the corresponding reference numerals raised by 50. This embodiment represents a further enhancement in that the virtual crossing lines can, in effect, be moved dynamically in order to maximize robustness and/or accuracy, potentially allowing the use of lower frame rate (hence lower cost) video capture and processing equipment.

If the plane of the road 54 with respect to the cameras is known (e.g. from initial survey, or processing of lane markings using perspective transformation) then the virtual lines need not be fixed in the road plane. This is advantageous as a crossing line transition could take place in between frame captures leading to time measurement errors and ultimately speed, height and length errors.

In this embodiment, a first image is captured (at time t1, shown in FIG. 7) when a vehicle 60 is in a certain zone (zone 1). The distance along the road from the point underneath the camera 51 of the visible part of the road at the front 57a and rear of the vehicle 58a (xf1, xr1) is derived using a perspective transformation (as discussed in WO02/092375).

Likewise, when the vehicle 60 has traveled further on, an image is captured (at time t2, as shown in FIG. 8) when the vehicle is detected in a second zone (zone 2). The distance along the road from the point underneath the camera 51 of the visible part of the road at the front 57b and rear 58b of the vehicle (xf2, xr2) is derived using the perspective transformation.

Using the measured positions (xf1, xf2, xr1, xr2), times (t1) and constant road data (camera height H), the speed (V), height (h) and length (l) of the vehicle can be derived:

$$V = - \frac{xf 1 - xf 2}{t 1 - t 2}$$

$$l = \frac{xf 1 \cdot xr 2 - xf 2 \cdot xr 1}{xr 1 - xr 2}$$

$$h = H ( 1 - \frac{xf 1 - xf 2}{xr 1 - xr 2} )$$

Derivations of these formulae can be found in Appendix B.

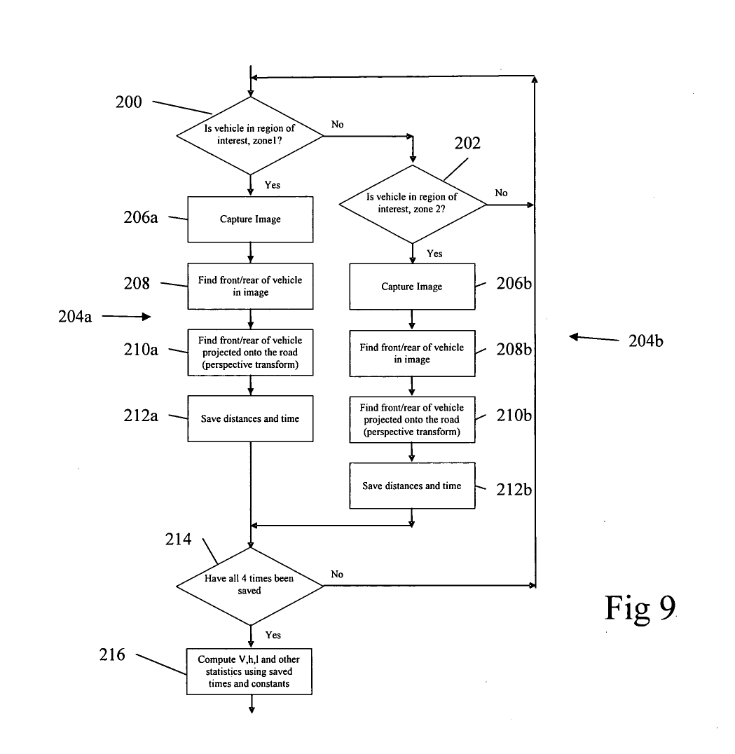

According to this embodiment, the method shown in FIG. 9 of the accompanying drawings can be used. In this method, the first step 200 is to determine whether a vehicle is in zone 1. If it is not, then it is determined at step 202 whether a vehicle is in zone 2. If there is no vehicle in either zone, then the method repeats from step 200 until there is.

Once it has been determined that there is a vehicle in one of the zones, the method proceeds down identical streams 204a and 204b depending upon which of the first or second zones the vehicle is located. In the following description, steps with a suffix “a” refer to the “zone 1” stream, where steps with a suffix “b” refer to the “zone 2” stream.

In each stream, once it has been identified that a vehicle is in the appropriate zone, an image is captured 206a/b, and the time of capture recorded. The position of the front and rear of the vehicle in the captured image is determined by the processing unit 6 at step 208a/b. These are converted by a perspective transform into a position along the road corresponding to the appropriate pair of xf1, xr1 and xf2, xr2 at step 210a/b. The two distances and the identical times to which they refer are recorded at step 212a/b.

The two streams recombine at step 214, where it is determined whether all four distances xf1, xr1, xf2 and xr2 and their associated times have been recorded. If not all times and distances are present, the method reverts to step 200 and repeats as before until the missing values are found. Once all the details are known, at step 216 the formulae given above are used to work out the values for speed, height, length and so on as discussed above.

For either embodiment, it is anticipated that the system will could achieve accuracy greater than 3% counting accuracy and 5% speed accuracy. The system is easy to install on a bridge or overhead gantry, hence installation costs are low and there is no need to break open the road surface. The video feed may be readily used, either online or recorded, for further traffic monitoring applications, e.g. automatic number plate recognition (ANPR) based systems, manual verification of traffic conditions. Mobile systems are envisaged; for example the system could be mounted on a moveable platform such as a tripod and transported to a survey site in the back of a vehicle. A single installation could feasibly cover a number of lanes, whilst an induction loop requires a sensor per lane.

If virtual lines are used, there are no installation or maintenance operations that require access to the carriageway, removing the disruption and cost of lane closures etc. Furthermore, the system is unaffected by works carried out on the carriageway, e.g. resurfacing, which would destroy inductive loops; such work could, however require lines to be repainted.

The proposed system requires only basic parameters for calibration (mounting height and pitch), which should be readily available. An induction loop does not monitor the space between loops or lanes, whereas the video processing could monitor the complete roadway.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

### APPENDIX A

Assuming that the vehicle is moving at constant speed, the speed can be estimated by considering the speed between the time when the front of the vehicle is at the virtual or actual first line 7 and then second line 8:

$$V = - \frac{xf 1 - xf 2}{tf 1 - tf 2}$$

By similar triangles (see FIG. 1 for geometry):

### So:

$$\frac{xf 1}{H} = \frac{xr 1}{H - h} and \frac{xf 2}{H} = \frac{xr 2}{H - h}$$

$$xr 1 = \frac{xf 1 ( H - h )}{H} and xr 2 = \frac{xf 2 ( H - h )}{H}$$

Speed can be derived two ways:

$$V = - \frac{( xf 1 - xf 2 )}{( tf 1 - tf 2 )} = - \frac{( xr 1 - xr 2 )}{( tr 1 - tr 2 )}$$

Substituting for xr1 and xr2 gives:

$$\frac{( xf 1 - xf 2 )}{( tf 1 - tf 2 )} = \frac{( \frac{xf 1 ( H - h )}{H} - \frac{xf 2 ( H - h )}{H} )}{( tr 1 - tr 2 )} = \frac{( H - h )}{H} \frac{( xf 1 - xf 2 )}{( tf 1 - tf 2 )}$$

$$\frac{1}{( tf 1 - tf 2 )} = \frac{( H - h )}{H * ( tr 1 - tr 2 )}$$

$$H * ( tr 1 - tr 2 ) = ( H - h ) * ( tf 1 - tf 2 )$$

and so:

$$h = H * \frac{( tf 1 - tf 2 - tr 1 + tr 2 )}{( tf 1 - tf 2 )} .$$

### Consider:

hence:

$$\frac{( H - h )}{H} = 1 - \frac{h}{H} = 1 - ( 1 - \frac{( tr 1 - tr 2 )}{( tf 1 - tf 2 )} ) = \frac{( tr 1 - tr 2 )}{( tf 1 - tf 2 )}$$

$$xr 1 = xf 1 * \frac{( H - h )}{H} = xf 1 \frac{( tr 1 - tr 2 )}{( tf 1 - tf 2 )} .$$

Consider the speed between the time when the front of the vehicle is at the virtual or actual first line 7 and then second line 8 with the speed when the front of the vehicle then the rear of the vehicle is at the virtual or actual first line 7:

$$V = - \frac{( xf 1 - xf 2 )}{( tf 1 - tf 2 )} = - \frac{( 1 + xf 1 - xr 1 )}{( tf 1 - tr 1 )}$$

Substituting for xr1:

$$- \frac{( xf 1 - xf 2 )}{( tf 1 - tf 2 )} = - \frac{( 1 + xf 1 - xf 1 \frac{( tr 1 - tr 2 )}{( tf 1 - tf 2 )} )}{( tf 1 - tr 1 )}$$

$$( xf 1 - xf 2 ) ( tf 1 - tr 1 ) = ( 1 + xf 1 - xf 1 \frac{( tr 1 - tr 2 )}{( tf 1 - tf 2 )} ) ( tf 1 - tf 2 ) = 1 ( tf 1 - tf 2 ) + xf 1 ( tf 1 - tf 2 ) - xf 1 ( tr 1 - tr 2 )$$

$$1 ( tf 1 - tf 2 ) = xf 1 ( tf 2 - tr 2 ) - xf 2 ( tf 1 - tr 1 ) \\ 1 = \frac{xf 1 ( tf 2 - tr 2 ) - xf 2 ( tf 1 - tr 1 )}{( tf 1 - tf 2 )}$$

### APPENDIX B

Assuming that the vehicle is moving at constant speed, the speed can be estimated by considering the speed between the time when the front of the vehicle is at its first and second positions at t=t1 and t=t2:

$$V = - \frac{xf 1 - xf 2}{t 1 - t 2}$$

By similar triangles (using FIGS. 7 and 8 for the relevant geometry):

$$\frac{xr 1}{H} = \frac{xf 1 + 1}{H - h} and \frac{xr 2}{H} = \frac{xf 2 + 1}{H - h}$$

so:

$$\frac{H - h}{H} = \frac{xf 1 + 1}{xr 1} = \frac{xf 2 + 1}{xr 2}$$

$$( xf 1 + 1 ) xr 2 = ( xf 2 + 1 ) xr 1$$

$$1 ( xr 1 - xr 2 ) = xf 1 xr 2 - xf 2 xr 1$$

$$1 = \frac{xf 1 xr 2 - xf 2 xr 1}{xr 1 - xr 2}$$

Substituting for l in one of the similar triangle equations gives:

$$\frac{x r 1}{H} = \frac{xf 1 + 1}{H - h}$$

$$\frac{xr 1 ( H - h )}{H} = xf 1 + \frac{xf 1 xr 2 - xf 2 xr 1}{xr 1 - xr 2} = \frac{\begin{matrix}xf 1 xr 1 - xf 1 xr 2 + \\ xf 1 xr 2 - xf 2 xr 1\end{matrix}}{xr 1 - x r 2} = \frac{( xf 1 - xf 2 ) xr 1}{xr 1 - xr 2} \\ \frac{H - h}{H} = \frac{xf 1 - xf 2}{xr 1 - xr 2} \\ h = H ( 1 - \frac{xf 1 - xf 2}{xr 1 - xr 2} )$$

1. A method of monitoring traffic on a road comprising the steps of:
capturing a plurality of images of the road using a camera mounted on a viewing point and associating a time of capture with each image,
determining, from said captured plurality of images, the positions of the portions of the road surface visible from said viewpoint corresponding to a front extremity and a rear extremity of the extent of a vehicle in said plurality of the captured images at two different times; and
determining from said positions and the times of said different times at least one characteristic of said vehicle or its motion.

2. The method of claim 1, wherein the characteristics of the vehicle or its motion include at least one of the vehicle length, height, width and speed.

3. The method of claim 1 2, wherein the determinations are made for the times when the vehicle blocks a view from the camera of a first line across said road and a second line across said road, the first and second lines being spaced from one another along said road; and when the first line and said second line are revealed due to passage of the vehicle along the road.

4. The method of claim 3, wherein the first line and second line are visible features on said road surface.

5. The method of claim 3, wherein the method also includes a step of assigning areas of road surface within the field of view of the camera as the first and second lines.

6. The method of claim 3, wherein the characteristics include vehicle speed and the method includes determining a speed of the vehicle using the time elapsed between the blocking and revealing of at least one of the first and second lines, combined with a measurement of a distance between the first and second lines.

7. The method of claim 3, wherein the height of the vehicle is calculated as:
$$h = H \frac{Δ tf - Δ tr}{Δ tf} ,$$
where:
h is the vehicle height,
H is the height above the road surface that the camera is mounted,
Δtf is the time elapsed between the closest edge of the vehicle to the camera in the field of view traversing the first and second lines, and
Δtr is the time elapsed between the farthest edge of the vehicle to the camera in the field of view traversing the first and second lines.

8. The method of claim 3, wherein the length of the vehicle is calculated as:
$$l = \frac{xf 1 \cdot Δ t 2 - xf 2 \cdot Δ t 1}{Δ tf} ,$$
where:
l is the length of the vehicle,
Δt1 is the time elapsed between the first line being blocked and revealed,
Δt2 is the time elapsed between the second line being blocked and revealed,
Δtf is the time elapsed between the vehicle blocking the first and second lines,
xf1 is the distance from the point on the road directly underneath the camera to the first line, and
xf2 is the distance from the point on the road directly underneath the camera to the second line.

9. The method of claim 1, wherein the times for which the positions are calculated may be the times at which the two images are captured.

10. The method of claim 9, further including capturing the first of said two images at a time when the vehicle is in a first zone within the field of view of the camera, and then waiting until the vehicle enters a second zone of the field of view before designating the second image as such.

11. The method of claim 9, wherein the speed of the vehicle is calculated according to:
$$V = \frac{Δ xf}{Δ t} ,$$
where:
Δxf is the change in distance from the camera along the road of the closest extremity of the vehicle to the camera, and
Δt is the time elapsed between the two times.

12. The method of claim 9, wherein the height of the vehicle is calculated according to:
$$l = \frac{xf 1 \cdot xr 2 - xf 2 \cdot xr 1}{xf 1 - xr 2} ,$$
where:
xf1 is the distance along the road from a point directly underneath the camera to the closest edge of the vehicle in a first one of the two images,
xf2 is the distance along the road from the point directly underneath the camera to the closest edge of the vehicle in a second one of the two images,
xr1 is the distance along the road from the point directly underneath the camera to the point on the road visible next to the farthest edge of the vehicle in the first of the two images, and
xr2 is the distance along the road from the point directly underneath the camera to the point on the road visible next to the farthest edge of the vehicle in the second of the two images.

13. The method of claim 9, wherein the height of the vehicle is calculated according to:
$$h = H ( 1 - \frac{xf 1 - xf 2}{xr 1 - xr 2} ) ,$$
where:
H is the height of the camera above the road,
xf1 is the distance along the road from a point directly underneath the camera to the closest edge of the vehicle in a first one of the two images,
xf2 is the distance along the road from the point directly underneath the camera to the closest edge of the vehicle in a second one of the two images,
xr1 is the distance along the road from the point directly underneath the camera to the point on the road visible next to the farthest edge of the vehicle in the first of the two images, and
xr2 is the distance along the road from the point directly underneath the camera to the point on the road visible next to the farthest edge of the vehicle in the second of the two images.

14. The method of claim 1, wherein the step of determining the position of the portions of the road surface visible at the extremities of the vehicle includes determining the shape of the road surface and using the shape of the road surface to transform a position within the image into a physical position on the road.

15. (canceled)

16. The method of claim 1, further including the step of applying a temporal high pass filter to the images, so that only fast changes in the images are considered.

17. The method of claim 3, further including determining the width of the vehicle dependent upon the amount of the line that is blocked by the vehicle.

18. The method of claim 3, further including the step of counting vehicles crossing one of the first and second lines.

19. A traffic monitoring apparatus, comprising:
a camera having an output and arranged so as to, in use, capture images and to output the captured images at the output,
a processing unit, coupled to the output of the camera and arranged to, in use, analyse the captured images, the processing unit including a position determination unit arranged to take as its input a plurality of images of a road and a vehicle travelling along the road captured by the camera, the plurality of images being taken of the road at different times, the time of capture of each image being associated with that image, the processing unit also arranged to output the positions of the portions of the road surface visible from the camera at the front and rear extremities of the extent of the vehicle in the captured images at two different times; and
a characteristic determining unit arranged to take as an input the positions and the times of the instants, the characteristic determining unit also arranged to output at least one characteristic of the vehicle or its motion.

20. The apparatus of claim 19, wherein the characteristics of the vehicle or its motion comprise at least one of the vehicle length, height, width and speed.

21. The apparatus of claim 19, wherein the position determining unit is arranged to determine the times when the vehicle blocks the view from the camera of a first line across the road and a second line across the road, the first and second lines being spaced from one another along the road; and when the first and second lines are revealed due to passage of the vehicle along the road.

22. The apparatus of claim 21, wherein the processing unit also includes a memory arranged to record in use the assignment of areas of road surface within the field of view of the camera as the first and second lines.

23. The apparatus of claim 21, wherein the characteristic determining unit is arranged to determine the vehicle speed using the time elapsed between the blocking and revealing of at least one of the first and second lines.

24. The apparatus of claim 21, wherein the characteristic determining unit is arranged to determine the height of the vehicle as:
$$h = H \frac{Δ tf - Δ tr}{Δ tf} ,$$
where:
h is the vehicle height, H is the height above the road surface that the camera is mounted,
Δtf is the time elapsed between the closest edge of the vehicle to the camera in the field of view traversing the first and second lines, and
Δtr is the time elapsed between the farthest edge of the vehicle to the camera in the field of view traversing the first and second lines.

25. The apparatus of claim 21, wherein the characteristic determining unit is arranged to determine the length of the vehicle as:
$$l = \frac{xf 1 \cdot Δ t 2 - xf 2 \cdot Δ t 1}{Δ tf} ,$$
where:
l is the length of the vehicle, Δt1 is the time elapsed between the first line being blocked and revealed,
Δt2 is the time elapsed between the second line being blocked and revealed,
Δtf is the time elapsed between the vehicle blocking the first and second lines,
xf1 is the distance from the point on the road directly underneath the camera to the first line, and
xf2 is the distance from the point on the road directly underneath the camera to the second line.

26. The apparatus of claim 19, wherein the position determining unit is arranged so as to calculate the positions for the times at which two images are captured.

27. The apparatus of claim 26, wherein the position determining unit is arranged to take, as an input, a first of the two images from when the vehicle is in a first zone within the field of view of the camera, and a second image from when the vehicle is in the a second zone of the field of view.

28. The apparatus of claim 26, wherein the characteristic determining unit is arranged to determine the speed of the vehicle according to:
$$V = \frac{Δ xf}{Δ t} ,$$
where:
Δxf is the change in distance from the camera along the road of the closest extremity of the vehicle to the camera, and
Δt is the time elapsed between the two times.

29. The apparatus of claim 26, wherein the characteristic determining unit is arranged to determine the height of the vehicle according to:
$$l = \frac{xf 1 \cdot xr 2 - xf 2 \cdot xr 1}{xr 1 - xr 2} ,$$
where:
xf1 is the distance along the road from a point directly underneath the camera to the closest edge of the vehicle in a first one of the two images,
xf2 is the distance along the road from the point directly underneath the camera to the closest edge of the vehicle in a second one of the two images,
xr1 is the distance along the road from the point directly underneath the camera to the point on the road visible next to the farthest edge of the vehicle in the first of the two images, and
xr2 is the distance along the road from the point directly underneath the camera to the point on the road visible next to the farthest edge of the vehicle in the second of the two images.

30. The apparatus of claim 26, wherein the characteristic determining unit is arranged to determine the height of the vehicle according to:
$$h = H ( 1 - \frac{xf 1 - xf 2}{xr 1 - xr 2} ) ,$$
where:
H is the height of the camera above the road,
xf1 is the distance along the road from a point directly underneath the camera to the closest edge of the vehicle in a first one of the two images,
xf2 is the distance along the road from the point directly underneath the camera to the closest edge of the vehicle in a second one of the two images,
xr1 is the distance along the road from the point directly underneath the camera to the point on the road visible next to the farthest edge of the vehicle in the first of the two images, and
xr2 is the distance along the road from the point directly underneath the camera to the point on the road visible next to the farthest edge of the vehicle in the second of the two images.

31. The apparatus of claim 19, wherein the position determining unit is arranged so as to determine the position of the road surface visible at the extremities of the vehicle by determining the shape of the road surface and using the shape of the road surface to transform a position within the image into a physical position on the road.

32. The apparatus of claim 19, wherein the processing unit also includes a temporal high pass filter, which acts on the captured images, such that only fast changes in the images are considered by the processing unit.

33. The apparatus of claim 19, wherein the characteristic determining unit may be arranged so as to determine the width of the vehicle dependent upon the amount of each line that is blocked by the vehicle.

34. The method of claim 1 further including a step that occurs prior to the listed steps, the prior occurring step including providing a suitable processor and a data carrier, the data carrier carrying processor instructions which, when loaded into the processor, cause the processor to carry out the subsequent steps of the method.
